(19) United States
(12) Patent Application Publication
(10) Pub. No.: US 2025/0341081 A1
(43) Pub. Date: Nov. 6, 2025

(54) TOUCHLESS FAUCET USING HAND TRACKING

(71) Applicant: TERRAVOX INDUSTRIES LLC, Farmingville, NY (US)

(72) Inventors: Philip Foo, Farmingville, NY (US); David Yee, Forest Hills, NY (US)

(73) Assignee: TERRAVOX INDUSTRIES LLC, Farmingville, NY (US)

(21) Appl. No.: 18/866,059

(22) PCT Filed: May 16, 2023
(86) PCT No.: PCT/US2023/022396

§ 371 Date: Nov. 14, 2024

Related U.S. Application Data
(60) Provisional application No. 63/343,021, filed on May 17, 2022.

(51) Int. Cl. E03C 1/05; F16K 31/04; F16K 31/06; G06F 3/01

(52) U.S. Cl. CPC E03C 1/057; F16K 31/04; F16K 31/0675; G06F 3/017

(57) ABSTRACT

Described is a touchless plumbing fixture system utilizing object tracking technology to allow a user's hand movement(s), gesture(s), or poses in three dimensional sensory space to control water flow rate, water temperature, and the enabling and disabling of water flow without physical contact or manual manipulation of the system or its parts.

### CROSS-REFERENCE TO RELATED APPLICATIONS

This application is an international patent application filed in accordance with the patent cooperation treaty. This application claims the priority benefit of U.S. Provisional Patent Application No. 63/343,021, filed 17 May 2022, and entitled “TOUCHLESS FAUCET USING HAND TRACKING.” The disclosure of U.S. Provisional Patent Application No. 63/343,021 is incorporated herein by reference in its entirety.

### BACKGROUND

Faucets are generally controlled by a handle(s) on manual faucets or a proximity sensor on automatic faucets. Typically, with a manual faucet, a user will be able to control the amount of hot and cold water desired but must physically interact with the handle(s). Faucet handles can have harmful germs on their surfaces. Contact with these surfaces can expose the user to potential health risks. Automatic faucets reduce these risks by allowing the user to turn on the flow of water by placing their hands in front of a proximity sensor.

### SUMMARY

Automatic faucets do not allow for touchless adjustments for water preferences like temperature and flow rate. While some touchless plumbing fixtures in the current market allow for indirect touchless control of water flow rate or water temperature these are not precise or ergonomic and often require a manual handle or a supplemental remote device, such as a smartphone, to operate.

The inventors recognized that what is needed is a faucet that provides convenient full contact-free control for a user to employ all the user's desired preferences. The present disclosure provides in various embodiments faucets and other water providing devices and systems that can achieve full contact-free control for a user to conveniently employ all user preferences and desires with respect to controlling water flow and temperature. There is a need for touchless alternatives to traditional faucets that can, under the control of a user, achieve the precision of a manual handle in adjusting both water flow rate and water temperature. Provided herein is an ergonomic touchless faucet and system for adjusting water flow rate and water temperature with precision and control equivalent to or better than can be achieved with a manual handle.

Provided herein, in various embodiments, is a touchless hand tracking faucet and system to enable touchless control of water flow rate and/or temperature of a faucet by a user's hand movements and/or gestures. The touchless faucet and system, in various embodiments, comprises hand tracking technology that recognizes gestures and movements in three-dimensional sensory space.

In various embodiments, provided herein is a touchless plumbing fixture system comprising a body for the dispensing of water, a mixing valve fluidly coupled to one or more water sources, an object tracking system which detects a control object in three-dimensional sensory space and recognizes movements, gestures, and/or poses of a control object to alter water flow rate, water temperature, and enable or disable the dispensing of water. A control object is any object which the tracking system is configured to identify such as a hand. Various movements, gestures, and/or poses are also recognized by the tracking system. The tracking system and various movements, gestures, poses, and control objects are all stored and preconfigured in a computer.

In various embodiments, provided herein is a touchless plumbing fixture system comprising a body to enable the dispensing of water, a mixing valve fluidly coupled to one or more water sources, and an object tracking system, which detects and recognizes a control object in three-dimensional sensory space and enables movements, gestures, or poses of the control object to transmit electrical signals to electronic components that control the water flow rate, water temperature, and enable or disable the delivery or dispensing of water.

The inventors have in various embodiments combined touchless plumbing fixtures with hand tracking technology to provide for sensitive hand recognition and movement tracking in three-dimensional sensory space. In various embodiments, the touchless plumbing fixture, system for touchless control of water flow rate and temperature, touchless hand tracking faucet, and methods of using the fixture, system and faucet, provide for interpreting complex gestures by accurately detecting a user's hands and its motions, then translating the detected hands and their motions into touchless control of water flow rate and water temperature for a user. The result is a touchless system which replicates the fine control of manual handles.

Various embodiments described can be used in a wide variety of scenarios including, but not limited to, residential properties, public facilities, restaurants, hospitality settings, commercial office space, sterile environments, and public parks. Various embodiments of the touchless fixtures, faucets, and systems described herein can be used in kitchens and bathrooms in, for example, sinks and showers.

In various embodiments described herein, a touchless plumbing fixture, a system for touchless control of water flow rate and temperature, and a touchless hand tracking faucet are provided that make use of hand tracking technology to enable a user's hand movement(s) and/or gesture(s) in three dimensional sensory space to adjust water flow rate, water temperature, and the enabling and disabling of water flow, i.e., on/off control, without physical contact or manual manipulation of the system or its parts. Among the many benefits provided by the various embodiments described herein are the convenience associated with touchless control that is equivalent to the experience a user would have with a manual handle, and the improved hygiene achieved by minimizing contact with historically high touch surfaces.

In various embodiments, provided herein is a touchless plumbing fixture comprising a discharge outlet with a passageway to conduct water in fluid communication with a mixing valve, the mixing valve in fluid communication with a cold water source and a hot water source, the mixing valve is operably coupled to one or more motors to independently control water flow rate and water temperature, an electrically operable valve in fluid communication with the passageway to conduct water, positioned between the mixing valve and the discharge outlet, a sensor with a field of detection for detecting a user control object in three dimensional sensory space, and a computer system operably coupled to the sensor, to the one or more motors, and to the electrically operable valve, the computer system preconfigured to recognize information comprising a plurality of gestures for touchless user commands provided by the sensor from the user control object.

In various embodiments, provided herein is a system for touchless control of water flow rate and temperature comprising a discharge outlet with a passageway to conduct water in fluid communication with a mixing valve, the mixing valve in fluid communication with a cold water source and a hot water source and operably coupled to one or more motors for independent control of water flow rate and water temperature, an electrically operable valve in fluid communication with the passageway to conduct water, positioned between the mixing valve and the discharge outlet, a sensor with a field of detection for detecting a user control object in three dimensional sensory space, and a computer system operably coupled to the sensor, to the one or more motors, and to the electrically operable valve, the computer system preconfigured to recognize information comprising a plurality of gestures for touchless user commands provided by the sensor from the user control object.

In various embodiments, provided herein is a touchless hand tracking faucet comprising a spout with a passageway to conduct water in fluid communication with a mixing valve, the mixing valve in fluid communication with one or more water source and operably coupled to one or more motors to independently control water flow rate and water temperature, an electrically operable valve in fluid communication with the passageway to conduct water and positioned between the mixing valve and a spout, a sensor with a field of detection for detecting a user control object in three dimensional sensory space, and a computer system operably coupled to the sensor, to the one or more motors, and to the electrically operable valve, the computer system preconfigured to recognize information comprising a plurality of gestures for touchless user commands provided by the sensor from the user control object.

In various embodiments, provided herein is a touchless hand tracking faucet, comprising object tracking technology operably interfaced with a mixing valve and computer comprising software preconfigured with user control objects and gestures for touchless user commands. In some embodiments, the touchless hand tracking faucet further comprises an artificial intelligence capable of adapting gesture recognition to user preference, habits, or combinations thereof.

In various embodiments, provided herein is a touchless plumbing fixture system comprising a body for dispensing water, a mixing valve fluidly coupled to one or more water sources, and an object tracking system, which detects a control object in three-dimensional sensory space and allows movements, gestures, or poses of the control object to alter water flow rate, water temperature, and enable or disable the delivery or dispensing of water.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 is a front plan view of an illustrative embodiment for a plumbing fixture system including an upper portion above a sink deck of a faucet and a lower portion below the sink deck of a controller box comprising a mixing valve, motors, computer, electronic control board and a plurality of sensors;

FIG. 2 is a cross sectional view of the faucet illustrating the components water travel through, through a line A-A of FIG. 1;

FIG. 3 is an enlarged partial view of the solid-circled area of the faucet mating components to a countertop of FIG. 2;

FIG. 4 is an exploded view of FIG. 2 for the faucet;

FIG. 5 is an isometric view of an embodiment for a wall mounted faucet;

FIG. 6 is a front view of controller box excluding the front cover;

FIG. 7 is an exploded view of the thermostatic mixing valve assembly for visibility;

FIGS. 8A, 8B are block diagrams of different embodiments described herein illustrating the mechanical system of the water's flow path;

FIG. 9 is a block diagram illustrating the electronic faucet system; and

FIGS. 10A, 10B, 10C, 10D, 10E illustrates a flowchart for processes of the logical controls for an illustrative embodiment of a faucet described herein.

### DETAILED DESCRIPTION

Before turning to the figures, which illustrate the exemplary embodiments in detail, it should be understood that the present disclosure is not limited to the details or methodology set forth in the description or illustrated in the figures. It should also be understood that the terminology is for the purpose of description only and should not be regarded as limiting. An effort has been made to use the same or like reference numbers throughout the drawings to refer to the same or like parts.

Throughout this application, thermostatic mixing valve is sometimes abbreviated as TMV, light emitting device is sometimes abbreviated as LED, and IR sensor stands for Infrared sensor.

In various embodiments described herein, electronic components are any devices which would aid or support the computer system. The electronic components are selected from one or more motors, one or more sensors with one or more fields of detection, one or more electrically operable valves, electronic displays and combinations thereof.

As used herein, a “mixing valve” is a device that changes the ratio between hot water source and cold water source to regulate the temperature and also regulates flow of the resulting mixture. A mixing chamber can, in various embodiments, be used as a substitute for a mixing valve, as a passive device, vessel, or fitting that combines the flow and temperature of a resulting mixture, but does not independently change or regulate the mixture's ratio.

In various embodiments, described herein is an electrically operable valve. In various embodiments, the electrically operable valve is designed to enable and disable the delivery or discharge of water. In various embodiments, the electrically operable valve can be a solenoid valve. In various embodiments as described herein, electrically operable valves are solenoid valves. Electronic faucets and valve assemblies, including mixing valves, are disclosed, for example, in U.S. Pat. Nos. 11,085,176, and 10,698,429 which are herein incorporated by reference.

Provided herein in various embodiments is a touchless plumbing fixture comprising a discharge outlet with a passageway to conduct water in fluid communication with a mixing valve, the mixing valve in fluid communication with a cold water source and a hot water source, the mixing valve is operably coupled to one or more motors to independently control water flow rate and water temperature; an electrically operable valve in fluid communication with the passageway to conduct water, positioned between the mixing valve and the discharge outlet; a sensor with a field of detection for detecting a user control object in three dimensional sensory space; a computer system operably coupled to the sensor, to the one or more motors, and to the electrically operable valve and comprising a tracking system preconfigured to analyze information sent from the sensor and recognize the user control object, a plurality of gestures as commands, and operate one or more electronic components.

In some embodiments of the touchless plumbing fixture the electrically operable valve is a solenoid valve. In some embodiments, the solenoid valve enables or disables the flow of water through the plumbing fixture independently of the setting of the mixing valve. In some embodiments, wherein the one or more electronic component is selected from one or more motors, one or more sensors with one or more fields of detection, one or more electrically operable valves, an electronic display, and combinations thereof. In some embodiments, the electronic display presents information about water temperature, water flow rate, an active state, a mode, or combinations thereof to the user. In some embodiments, the computer system further comprises an electronic control board that sends and receives signals to and from the one or more electronic components. In some embodiments, the user control object is a hand or a pair of hands. In some embodiments, the plurality of gestures are selected from hand gestures, poses, speech, sounds, other body gestures, or various combinations thereof. In some embodiments, the plurality of gestures are selected from a water temperature gesture, a water flow rate gesture, a gesture to activate and deactivate the electrically operable valve, or combinations thereof. In some embodiments, the touchless plumbing fixture further comprises a second sensor with a secondary field of detection. In some embodiments, the computer system is preconfigured to switch between an active mode and a standby mode and when the computer system is in the standby mode and the second sensor detects the control object in the secondary field of detection the computer system will switch to the active mode. In some embodiments, when the second sensor does not detect the user in the secondary field of detection after a predefined period of time, the computer system switches to the standby mode. In some embodiments, the computer system is preconfigured to switch between an active mode and a standby mode and when the computer system is in the standby mode and the sensor detects the control object in the field of detection the computer system switches to the active mode. In some embodiments, when the sensor does not detect the user in the field of detection after a predefined period of time, the computer system switches to the standby mode. In some embodiments, the sensor is one or more digital cameras. In some embodiments, the sensor is one or more infrared cameras. In some embodiments, the electronic component is an audio sensor operably coupled to the computer system for detecting audio commands or an audio device for providing audio feedback of command recognition to the user. In some embodiments, the mixing valve can be a mixing chamber.

In some embodiments, a temperature sensor is operably coupled to the computer system that is preconfigured with an anti-freeze mode to prevent water from freezing. In some embodiments, water temperature is measured by output signals from the temperature sensor while the computer system is not in operation and when the water temperature falls below a preconfigured threshold then the computer system will begin anti-freeze mode and activate the electrically operable valve. In some embodiments, while in anti-freeze mode the computer system will continually monitor the water temperature by measuring the output signals of the temperature sensor and when the water temperature is above the preconfigured threshold then the computer system will end anti-freeze mode and deactivate the electrically operable valve. In some embodiments, the discharge outlet is a spout. In some embodiments, the plumbing fixture is selected from a sink, a shower, a tub, a fountain, or combinations thereof. In some embodiments, the plumbing fixture is a faucet.

In some embodiments, the touchless plumbing fixture is configured to recognize user control objects and gestures by analyzing images captured by the sensor from a particular vantage point to computationally represent a portion of the user control object from the plurality of user control objects as one or more mathematically represented 3D surfaces. In some embodiments, in the system for touchless control of water flow rate and temperature each 3D surface corresponding to a cross-section of the portion of the user control object is recognized from a plurality of edge points of the portion of the user control object in the image, tangent lines extending from the sensor to at least two edge points of the plurality of edge points, a centerline corresponding to the tangent lines, or combinations thereof, to reconstruct, or shape fit, the user control object in the 3D space. In some embodiments, the computer system is preconfigured with a learning mode to add new user control objects to the plurality of user control objects and add new gestures to the plurality of gestures.

In some embodiments of the touchless plumbing fixture, the computer further comprises an artificial intelligence capable of adapting gesture recognition to user preference, habits, or combinations thereof. In some embodiments, the computer system is preconfigured with a remapping mode to allow the user to select which user control objects from the plurality of user control objects and gestures from the plurality of gestures are assigned to a respective touchless user command. In some embodiments, the touchless plumbing fixture further comprises a searching mode that uses a sensor to capture an image, finds a control object, creates a 3D model of the control object, applies reference points to the 3D model, then determines an axial position for the reference points on the 3D model. In some embodiments, the computer system continuously operates in searching mode until the axial position of the image matches a preconfigured gesture stored in the computer system and wherein, when the image that matches the preconfigured gesture becomes an active gesture the computer system switches to a matching mode. In some embodiments, the computer system continuously operates in searching mode until an axial position for the image matches a preconfigured gesture stored in the computer system and wherein, when the image that matches the preconfigured gesture becomes an active gesture the computer system switches to a matching mode. In some embodiments, when in the matching mode, the computer system interfaces with the sensor to continuously capture a new image, as a current image, after a predefined period of time and compares the current image with a previously captured image, as a prior image. In some embodiments, when the current image is the one most recently captured and the prior image is the one immediately preceding the current image and for each image, the computer system finds a control object, creates a 3D model of the control object, applies reference points to the 3D model, determines an axial position for the reference points on the 3D model, and confirms the axial position matches the active gesture. In some embodiments, the computer system determines the difference between the axial positions of the current image and the prior image and then correlates that difference into a change in the state of the plumbing fixture recognized by the active gesture. In some embodiments, the computer system continuously operates in the matching mode until parameters to end matching mode are met and then the computer system switches to the searching mode.

In various embodiments, provided herein is a system for touchless control of water flow rate and temperature comprising a discharge outlet with a passageway to conduct water in fluid communication with a mixing valve; the mixing valve in fluid communication with a cold water source and a hot water source and operably coupled to one or more motors for independent control of water flow rate and water temperature; an electrically operable valve in fluid communication with the passageway to conduct water, positioned between the mixing valve and the discharge outlet; a sensor with a field of detection for detecting a user control object in three dimensional sensory space, and a computer system operably coupled to the sensor, to the one or more motors, and to the electrically operable valve, the computer system preconfigured with a tracking system to analyze information sent from the sensor and recognize a plurality of control objects, a plurality of gestures as commands, and operate an electronic component. In some embodiments, the computer system further comprises an electronic control board that sends and receives signals to and from the electronic component. In some embodiments, the electronic component is selected from one or more motors, one or more sensors with one or more fields of detection, one or more electronically operable valves, one or more electronic displays, an audio sensor for detecting audio commands, an audio device for providing audio feedback of command recognition to the user, and combinations thereof. In some embodiments, the electronic component further comprises an electronic display that visually relays information about water temperature, water flow rate, an active state, a mode, or combinations thereof. In some embodiments, the user control object is a hand or pair of hands. In some embodiments, the plurality of gestures are hand gestures. In some embodiments, the plurality of gestures comprise a water temperature gesture, a water flow rate gesture, a gesture to activate and deactivate the electrically operable valve, or combinations thereof.

In some embodiments, the system for touchless control of water flow rate and temperature further comprises a second sensor with a secondary field of detection. In some embodiments, the computer system is preconfigured to switch between a standby mode and an active mode. In some embodiments, the computer system is in the standby mode and the second sensor detects the control object in the secondary field of detection the computer system will switch to the active mode. In some embodiments, the second sensor does not detect the user in the secondary field of detection, during active mode, after a predefined period of time, the computer system will switch to the standby mode.

In some embodiments, the computer system is preconfigured to switch between an active mode and a standby mode and when the computer system is in the standby mode and the sensor detects the control object in the field of detection the computer system will switch to the active mode. In some embodiments, when the sensor does not detect the user in the field of detection after a predefined period of time, the computer system will switch to the standby mode. In some embodiments, the sensor is one or more digital cameras. In some embodiments the sensor is one or more infrared cameras.

In some embodiments in the system for touchless control of water flow rate and temperature, a temperature sensor is operably coupled to the computer system that is preconfigured with an anti-freeze mode to prevent water from freezing. In some embodiments, where water temperature is measured by output signals from the temperature sensor while the computer system is not in operation and when the water temperature falls below a preconfigured threshold then the computer system will begin anti-freeze mode and activate the electrically operable valve. In some embodiments, while in anti-freeze mode the computer system will continually monitor the water temperature by measuring the output signals of the temperature sensor and when the water temperature is above the preconfigured threshold then the computer system will end anti-freeze mode and deactivate the electrically operable valve.

In some embodiments of the system for touchless control of water flow rate and temperature the discharge outlet is a spout. In some embodiments, the system comprises a plumbing fixture selected from a sink, a shower, a tub, a fountain, or combinations thereof. In some embodiments of the system for touchless control of water flow rate and

temperature the computer system is configured to recognize user control objects and gestures by analyzing images captured by the sensor from a particular vantage point to computationally represent a portion of the user control object from the plurality of user control objects as one or more mathematically represented 3D surfaces. In some embodiments, in the system for touchless control of water flow rate and temperature of claim each 3D surface corresponding to a cross-section of the portion of the user control object is recognized from a plurality of edge points of the portion of the user control object in the image, tangent lines extending from the sensor to at least two edge points of the plurality of edge points, a centerline corresponding to the tangent lines, or combinations thereof, to reconstruct, or shape fit, the user control object in the 3D space. In some embodiments, the computer system is preconfigured with a learning mode to add new user control objects to the plurality of user control objects and add new gestures to the plurality of gestures.

In some embodiments of the system for touchless control of water flow rate and temperature, the computer further comprises an artificial intelligence capable of adapting gesture recognition to user preference, habits, or combinations thereof. In some embodiments, the computer system is preconfigured with a remapping mode to allow the user to select which user control objects from the plurality of user control objects and gestures from the plurality of gestures are assigned to a respective touchless user command. In some embodiments, the system for touchless control of water flow rate and temperature further comprises a searching mode that uses a sensor to capture an image, finds a control object, creates a 3D model of the control object, applies reference points to the 3D model, then determines an axial position for the reference points on the 3D model. In some embodiments, the computer system continuously operates in searching mode until the axial position of the image matches a preconfigured gesture stored in the computer system and wherein, when the image that matches the preconfigured gesture becomes an active gesture the computer system switches to a matching mode. In some embodiments, when in the matching mode, the computer system interfaces with the sensor to continuously capture a new image, as a current image, after a predefined period of time and compare the current image with a previously captured image, as a prior image. In some embodiments, wherein the current image is one most recently captured and the prior image is the one immediately preceding the current image and for each image, the computer system finds a control object, creates a 3D model of the control object, applies reference points to the 3D model, determines an axial position for the reference points on the 3D model, and confirms the axial position matches the active gesture. In some embodiments, the computer system determines the difference between the axial positions of the current image and the prior image and then correlates that difference into a change in the state of the plumbing fixture recognized by the active gesture. In some embodiments, the computer system continuously operates in the matching mode until parameters to end matching mode are met and then the computer system will switch to the searching mode. In some embodiments, the mixing valve can be a mixing chamber.

In various embodiments, provided herein is a touchless hand tracking faucet, comprising a spout with a passageway to conduct water in fluid communication with a mixing valve; the mixing valve in fluid communication with one or more water source and operably coupled to one or more motors to independently control water flow rate and water temperature; an electrically operable valve in fluid communication with the passageway to conduct water and positioned between the mixing valve and the spout; a sensor with a field of detection for detecting a user control object in three-dimensional sensory space, and a computer system operably coupled to the sensor, to the one or more motors, and to the electrically operable valve, the computer system preconfigured with hand tracking software to analyze information sent from the sensor and recognize a user's hands as control objects, its gestures as commands, and operate an electronic component.

In some embodiments, the electronic component is selected from one or more motors, one or more sensors with one or more fields of detection, one or more electrically operable valves, electronic displays, an audio sensor for detecting audio commands, an audio device for providing audio feedback of command recognition to the user, and combinations thereof. In some embodiments, the one or more water source comprises a cold water source and a hot water source.

In some embodiments, a temperature sensor is operably coupled to the computer system that is preconfigured with an anti-freeze mode to prevent water from freezing. In some embodiments, water temperature is measured by output signals from the temperature sensor while the computer system is not in operation and when the water temperature falls below a preconfigured threshold then the computer system will begin anti-freeze mode and activate the electrically operable valve. In some embodiments while in anti-freeze mode the computer system will continually monitor the water temperature by measuring the output signals of the temperature sensor and when the water temperature is above the preconfigured threshold then the computer system will end anti-freeze mode and deactivate the electrically operable valve.

In some embodiments of the touchless hand tracking faucet the user control object is a hand. In some embodiments, the plurality of gestures are hand gestures. In some embodiments, the plurality of gestures are selected from a water temperature gesture, a water flow rate gesture, a gesture to activate and deactivate the electrically operable valve, or combinations thereof.

In some embodiments, the touchless hand tracking faucet is configured to recognize user control objects and gestures by analyzing images captured by the sensor from a particular vantage point to computationally represent a portion of the user control object from the plurality of user control objects as one or more mathematically represented 3D surfaces. In some embodiments, in the system for touchless control of water flow rate and temperature of claim each 3D surface corresponding to a cross-section of the portion of the user control object is recognized from a plurality of edge points of the portion of the user control object in the image, tangent lines extending from the sensor to at least two edge points of the plurality of edge points, a centerline corresponding to the tangent lines, or combinations thereof, to reconstruct, or shape fit, the user control object in the 3D space. In some embodiments, the computer system is preconfigured with a learning mode to add new user control objects to the plurality of user control objects and add new gestures to the plurality of gestures.

In some embodiments of the touchless hand tracking faucet the computer further comprising an artificial intelligence capable of adapting gesture recognition to user preference, habits, or combinations thereof. In some embodiments, the computer system is preconfigured with a remapping mode to allow the user to select which user control objects from the plurality of user control objects and which gestures from the plurality of gestures are assigned to a respective touchless user command. In some embodiments, the touchless hand tracking faucet further comprises a searching mode that uses a sensor to capture an image, finds a control object, creates a 3D model of the control object, applies reference points to the 3D model, then determines an axial position for the reference points on the 3D model. In some embodiments, the computer system continuously operates in searching mode until the axial position of the image matches a preconfigured gesture stored in the computer system and wherein, when the image that matches the preconfigured gesture becomes an active gesture the computer system switches to a matching mode. In various embodiments, the computer system continuously operates in searching mode until an axial position for the image matches a preconfigured gesture stored in the computer system and the computer system switches to a matching mode when the image that matches the preconfigured gesture becomes an active gesture. In some embodiments, when in the matching mode, the computer system interfaces with the sensor to continuously capture a new image, as a current image, after a predefined period of time and compare the current image with a previously captured image, as a prior image. In some embodiments, wherein the current image is one most recently captured and the prior image is the one immediately preceding the current image, and for each image, the computer system finds a control object, creates a 3D model of the control object, applies reference points to the 3D model, determines an axial position for the reference points on the 3D model, and confirms the axial position matches the active gesture. In some embodiments, wherein the current image is one most recently captured and the prior image is the one immediately preceding the current image, and for each image, the computer system finds a control object, creates a 3D model of the control object, applies reference points to the 3D model, determines the axial position of the reference points on the 3D model, and confirms the axial position matches the active gesture. In some embodiments, the computer system determines the difference between the axial positions of the current image and the prior image and then correlates that difference into a change in the state of the plumbing fixture recognized by the active gesture. In some embodiments, the computer system establishes the difference between an axial position for the current image and the prior image and then correlates that difference into a change in the state of the plumbing fixture recognized by the active gesture. In some embodiments, the computer system continuously operates in the matching mode until parameters to end matching mode are met and then the computer system switches to the searching mode. In some embodiments, the mixing valve can be a mixing chamber. In some embodiments, the electronic component further comprises an electronic display that visually relays information about water temperature, water flow rate, an active state, a mode, or combinations thereof.

In some embodiments, the touchless hand tracking faucet further comprises a second sensor with a secondary field of detection. In some embodiments, the computer system is preconfigured to switch between a standby mode and an active mode. In some embodiments, when the computer system is in the standby mode and the second sensor detects the control object in the secondary field of detection the computer system will switch to the active mode. In some embodiments, when the second sensor does not detect the user in the secondary field of detection, during active mode, after a predefined period of time, the computer system will switch to the standby mode. In some embodiments, the computer system is preconfigured to switch between an active mode and a standby mode and when the computer system is in the standby mode and the sensor detects the control object in the field of detection the computer system will switch to the active mode. In some embodiments, when the sensor does not detect the user in the field of detection after a predefined period of time, the computer system will switch to the standby mode. In some embodiments, the sensor is one or more digital cameras. In some embodiments, the sensor is one or more infrared cameras.

In various embodiments, a touchless hand tracking faucet is provided which comprises object tracking technology operably interfaced with a computer, the computer comprising software preconfigured with user control objects and gestures for touchless user commands and operably connected to a mixing valve and an electrically operable valve.

In various embodiments provided is a touchless plumbing fixture system comprising a body for dispensing water; a mixing valve fluidly coupled to one or more water sources; an object tracking system which detects a control object in three dimensional sensory space and provides for movements, gestures, or poses of the control object to transmit electrical signals to one or more electronic components that control water flow rate, water temperature, and enable or disable the dispensing of water.

In various embodiments, provided herein is a touchless water reservoir comprising one or more outlets for dispensing water; one or more electrically operable valves; an object tracking system, which detects a control object in three dimensional sensory space and allows movements, gestures, or poses of the control object to transmit electrical signals to one or more electronic components that control water flow rate and enable or disable the dispensing of water. In some embodiments, the water reservoir is a fountain. In some embodiments the fountain is ornamental.

In various embodiments, provided herein is a touchless faucet, comprising a computer system which comprises a searching mode that uses a sensor to capture an image, finds a control object, creates a 3D model of the control object, applies reference points to the 3D model, then determines the axial position of the reference points on the 3D model. In some embodiments, the computer system continuously operates in searching mode until the axial position of the image matches a preconfigured gesture stored in the computer system and wherein, when the image that matches the preconfigured gesture becomes an active gesture the computer system switches to a matching mode. In some embodiments, when the touchless faucet is in the matching mode, the computer system interfaces with the sensor to continuously capture a new image after a predefined period of time and compare the new image with a previously captured image. In some embodiments, a current image is one most recently captured and a prior image is the one immediately preceding the current image, and for each image, the computer system finds a control object, creates a 3D model of the control object, applies reference points to the 3D model, determines the axial position of the reference points on the 3D model, and confirms the axial position matches the active gesture. In some embodiments, the computer system determines the difference between the axial positions of the current image and the prior image and then correlates that difference into a change in the state of the plumbing fixture recognized by the active gesture. In some embodiments, the computer system continuously operates in the matching mode until parameters to end matching mode are met and then the computer system switches to the searching mode.

In various embodiments described herein an electronic display is provided. In various embodiments, the electronic display presents information about water temperature, water flow rate, and the plumbing fixture's state or mode to the user. In various embodiments, the electronic display can be selected from an electronic screen, an array of lights, and images or symbols.

The use of hand tracking in three-dimensional sensory space, such as extended reality (XR), and in some embodiments using artificial intelligence (AI) to aid hand tracking technology, provides for the accurate detection of hand gestures and superior touchless control than has previously been achieved. By utilizing the latest hand tracking sensors, programs, and compact computer systems, it is possible in various embodiments described herein, to supplant the functionality of manual touch handles. This enables touchless adjustment of water temperature, water flow rate, and the activating/deactivating of the flow of water within a single unit by using distinct hand movements or gestures. Provided herein in various embodiments is a touchless hand tracking faucet, comprising object tracking technology operably interfaced with a valve and a computer comprising software preconfigured with user control objects and gestures for touchless user commands. In various embodiments, the touchless hand tracking faucet comprises an artificial intelligence capable of adapting to user preference. In various embodiments an artificial intelligence is provided that is capable of adapting control object recognition to user preference to obtain a touchless hand tracking faucet that evolves to be customized to a user's needs and preferences.

In various embodiments, the computer system provided herein is an electronic device preconfigured with hand tracking software for recognizing a user's hands as control objects, its gestures as commands, and capable of operating electronic components.

In various embodiments, a computer system further comprises an electronic control board that sends and receives signals to and from the one or more electronic components. See, for example, U.S. Pat. Nos. 11,085,176, and 10,698,429 which are herein incorporated by reference.

In various embodiments, a computer system is preconfigured to switch between an active mode and a standby mode. Standby mode is, in various embodiments, when minimal power is used by the plumbing fixture, faucet, or system, and limited sensor detection is available with the primary purpose of detecting the user to switch to the active mode; the active mode is when the plumbing fixture uses the necessary power to operate. In normal operation, all sensors and systems are fully functional. Standby mode enables the plumbing fixture to use minimal power and switch to active mode upon detecting a control object using a second sensor in a secondary field of detection. The second sensor has characteristics of low power consumption and a simple emitter and receiver. The second sensor, in various embodiments, is designed to detect the distance an object is from the second sensor and relay that information to the computer system. The active mode is when the plumbing fixture uses the necessary power to operate normally with sensors and systems fully functional. In the active mode, after a predefined period of time without detecting the user in the secondary field of detection using the second sensor, the computer system will switch to the standby mode. The predefined period of time during active mode can be a specific time interval for example, 5 minutes, 10 minutes, or 30 minutes. The amount of time can be set to be sufficient for the user to complete their task with the plumbing fixture idle while in active mode. See, for example, U.S. Pat. No. 10,663,938 which is herein incorporated by reference.

In various embodiments, described herein is a system for touchless control of water flow rate and temperature comprising a discharge outlet with a passageway to conduct water in fluid communication with a mixing valve, the mixing valve in fluid communication with a cold water source and a hot water source and operably coupled to one or more motors for independent control of water flow rate and water temperature, an electrically operable valve in fluid communication with the passageway to conduct water, positioned between the mixing valve and the discharge outlet, a sensor with a field of detection for detecting a user control object in three dimensional sensory space, and a computer system operably coupled to the sensor, and, in some embodiments, electronic components. The computer system comprises a tracking system preconfigured to recognize a user control object and a plurality of gestures for touchless user commands. Electronic components can comprise one or more motors, one or more sensors, one or more electrically operable valves, electronic displays, and combinations thereof. See, for example, U.S. Pat. Nos. 11,085,176 and 10,698,429 which are herein incorporated by reference.

Manual handles provide a high degree of control for a user to change the state of a plumbing fixture, such as increasing flow of hot water relative to cold water to adjust the temperature or turning off the flow of water entirely. In various embodiments, described herein, a system for touchless control of water flow rate and water temperature which uses advanced gesture recognition software to accurately interpret touchless user commands is provided. The system can adjust a mixing valve and an electrically operable valve to deliver water to the user at the desired water flow rate and water temperature in accordance with the preferences as set by a user. Such preferences can be achieved, in various embodiments, by user commands. The touchless user commands provide the user the ability to control and change the state of the plumbing fixture without physical contact with the various embodiments described herein.

Hand gestures, poses, speech, sounds, other body gestures or various combinations thereof can, in various embodiments, be described as touchless user commands, or just “commands”, that are actions with an intention to change the state of the plumbing fixture. In various embodiments herein, for example, a specific command is used to adjust water temperature, a different command is used for adjusting water flow rate, and another separate command for enabling or disabling the flow of water. In each instance, the state of the plumbing fixture would change based on the respective command used.

The state of the plumbing fixture, as used herein, describes internal conditions or settings of the plumbing fixture at a specific point in time that directly correlates with control of water delivery, both flow and temperature, to the user in accordance with user determined selections achieved by the user with touchless commands, such as gestures recognized by the preconfigured computer software. The state of the plumbing fixture can be ever changing and evolving based on the conditions or settings as a result of the user's commands. For example, if the plumbing fixture is off, where the delivery of water is disabled, that is its current state. If the user wants to open the flow of water out of the plumbing fixture, the user's command will cause the plumbing fixture to change its state to an ON condition, where the delivery of water is enabled. Changes to the temperature and/or flow rate of the water delivery to any degree of temperature and/or flow rate also correlates with equivalent changes in the plumbing fixture's state.

In various embodiments, the system for touchless control of water flow rate and temperature can have an active mode and a standby mode. The primary purpose of standby mode is to use minimal power and switch to active mode upon detecting the control object using a second sensor in a secondary field of detection. The second sensor has characteristics of low power consumption and a simple emitter and receiver. The second sensor is incapable of interpreting gestures or complex movements, instead it detects the distance an object is in front of the sensor and relays that information to the computer system. The active mode is when the plumbing fixture uses the necessary power to operate normally with sensors and systems fully functional. In the active mode, after a predefined period of time without detecting the user in the secondary field of detection with the second sensor, the system will switch to the standby mode. The predefined period of time during active mode can be a specific time interval for example, 5 minutes, 10 minutes, or 30 minutes. The amount of time should be sufficient for the user to complete their task with the plumbing fixture idle while in active mode. See, for example, U.S. Pat. No. 10,663,938 which is herein incorporated by reference.

In various embodiments, the system for touchless control of water flow rate and temperature further comprises an anti-freeze mode to prevent water from freezing in domestic pipes while not in operation by the user. In operation, the computer system continually monitors the water temperature by measuring the output signals from the temperature sensor and when the water temperature falls below a preconfigured threshold then the computer system will begin anti-freeze mode and the electrically operable valve will enable the flow of water. While in anti-freeze mode, the temperature sensor will continue to monitor the temperature in the system and once the water temperature is above the preconfigured threshold then the computer system will end anti-freeze mode and the electrically operable valve will disable the flow of water.

The computer system, in various embodiments, continually monitors water temperature by measuring the output signals from the temperature sensor when the fixture, system, or faucet, described in various embodiments, is not in operation by the user and when the water temperature falls below a preconfigured threshold then the computer system will begin anti-freeze mode and activate the electrically operable valve. While in anti-freeze mode the computer system will continually monitor the water temperature by measuring the output signals of the temperature sensor and when the water temperature is above the preconfigured threshold then the computer system will end anti-freeze mode and deactivate the electrically operable valve.

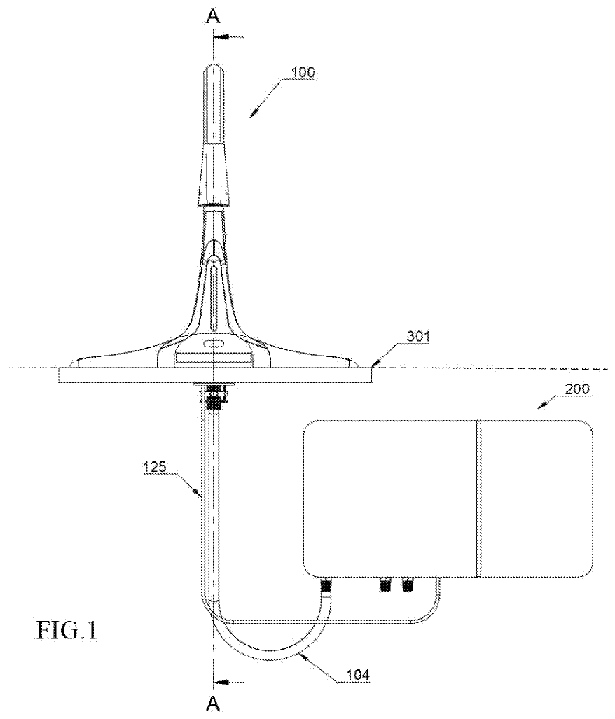

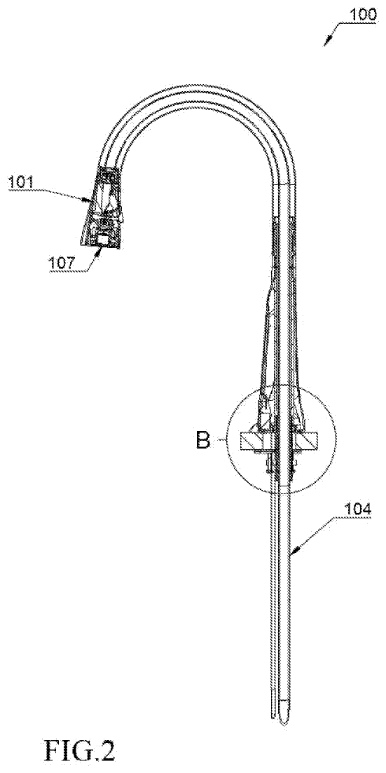

FIG. 1 shows an exemplary embodiment of a faucet 100 configured to receive input signals from the data line 125 and relay them to the controller box 200 to interpret and operate components to send water through the hose 104 to the faucet 100 at a certain temperature and flow rate, using a thermostatic mixing valve 213 (not shown), or to start or stop the flow of water, using a solenoid valve 215 (not shown), based on the signals received from the user through the sensors on the faucet 100. The faucet 100, located above the countertop 301, is coupled to the controller box 200, located below the countertop 301, through a hose 104 and is electrically coupled to the controller box 200 through the data line 125. Referring to FIG. 2, a sectional view of FIG. 1 is shown illustrating the flow of water through components in the faucet 100 from the controller box 200 (FIG. 1). The hose 104 is coupled from the controller box 200 to the faucet spout 101 and an aerator 107 to allow the flow of water to the end user.

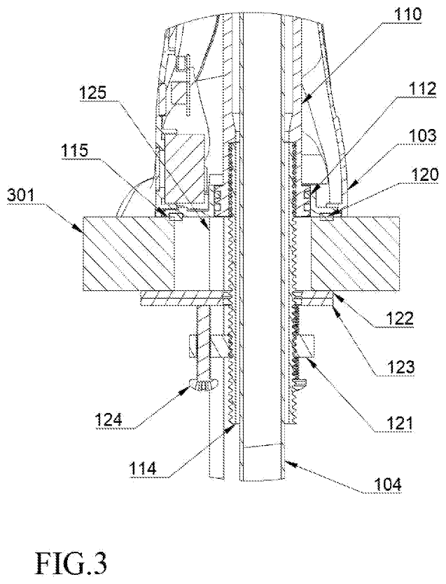

Referring to FIG. 3, a detail of faucet components for mating the faucet 100 to a countertop 301 is shown in accordance with some embodiments described herein. The faucet 100 can be sealed to the countertop 301 by using a preformed gasket 120 that is coupled to a matching channel on the bottom plate 115. In some embodiments, the material for the gasket 120 is made of rubber for ease of manufacturing and reliability. However, other materials can be used such as, for example, neoprene or butene, as would be understood by persons of skill in the art. When sufficient compression force is applied to the gasket 120, the gasket 120 deforms and seals itself onto the countertop 301. In order to create this force, the faucet comprises a fully threaded faucet shank 114 that acts as an anchor for the locking nut 121. The fully threaded faucet shank 114 is installed in the faucet 100 by coupling to the hose sleeve 110. A rubber washer 122, a metal washer 123, a locking nut 121, that is threaded, and screws 124 are coupled together to the faucet shank 114. In some embodiments the locking nut 121 is threaded until the rubber washer 122 and metal washer 123 compress onto the countertop 301, between the faucet 100 and the bottom plate 115. The screws 124 can then be hand tightened to further add clamping force to the faucet 100 onto a countertop 301. The hose sleeve 110 is coupled to o-rings 112 of various quantities, one or more, to provide additional seal onto the bottom plate 115. The bottom plate 115 is coupled to the hose sleeve 110, o-rings 112, faucet body 103 and faucet front cover 102 (not shown in FIG. 3). The data line 125 and the hose 104, pass through the countertop 301 from the faucet 100 to the controller box 200 (not shown in FIG. 3).

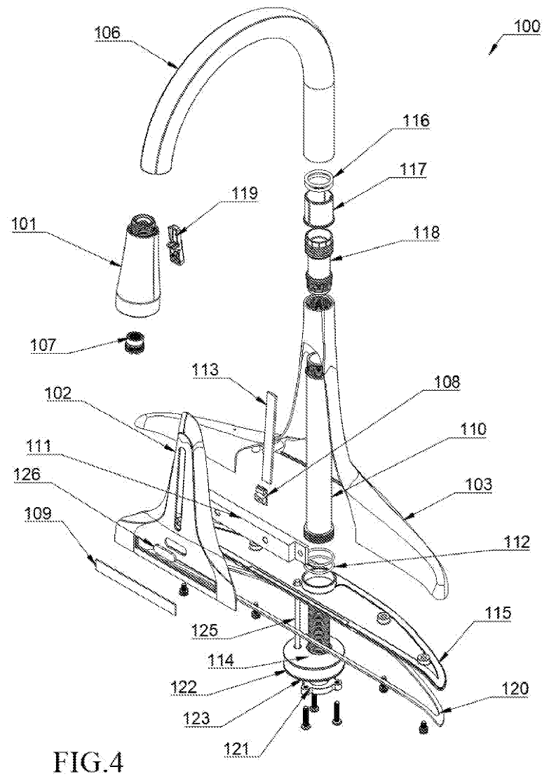

FIG. 4 shows an exploded view of a touchless faucet 100 in accordance with some embodiments, designed to have both a camera and an IR sensor work in tandem that can achieve at least the functionality of a physical handle in lieu of a physical handle.

FIG. 4 is an exploded view of a touchless faucet 100, a pull down style faucet, in accordance with some embodiments. The faucet spout 101 is coupled to a retractable hose 104 (not shown) which can be pulled out from the faucet neck 106. The toggle 119 allows the user to manually switch between two spray functions. The faucet spout 101 is coupled to the hose 104 (not shown) and the faucet neck 106 and, in some embodiments, an aerator 107. In other embodiments, the faucet spout 101 is not retractable from the faucet neck 106. Instead, the faucet spout 101 and faucet neck 106 are one unit, without a hose 104 (not shown). In some embodiments, as shown in FIG. 4, an IR sensor 108 and a camera 111 are coupled to a faucet front cover 102. The IR sensor 108 and the camera 111 are sensitive to exposure to water, dirt, debris, and excessive intense light sources. A glass 109 can, in various embodiments, be used to protect the camera 111 and can be coupled to the faucet front cover 102. A similar protective glass 126 can be used, in some embodiments, to protect the IR sensor 108 from the same risks. The material of the protective glass can be of a variety of materials known to persons of skill in the art. In some embodiments, the material of the protective glass has characteristics like scratch resistance, hydrophobic properties, visible light resistance properties, and combinations thereof.

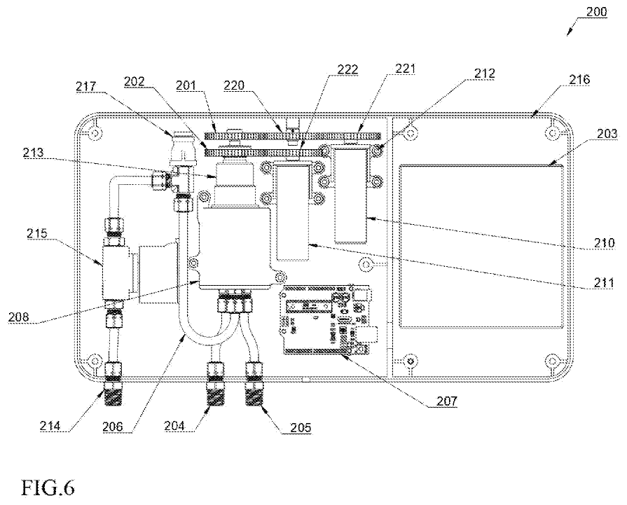

When interacting with the faucet 100, a user can, in various embodiments, receive visual feedback from an electronic display. In some embodiments, the electronic display is a Light Emitting Device Array or LED Assembly 113. The LED Assembly 113 is, in some embodiments, coupled to the Front Cover 102 and electrically coupled to the controller box 200. The LED Assembly 113 will display a series of lights in an intuitive sequence and color scheme that can be easily perceived by the user. (i.e., in some embodiments, Blue is cold, Red is hot). The LED Assembly 113 will remain on when the faucet is in “active” mode and illuminate various series of lights to display temperature and/or flow rate to the user. When not in active mode, the LED Assembly 113 will de-energize and will not illuminate. The LED Assembly 113, IR Sensor 108, and Camera 111 are all, in various embodiments, electrically coupled to a Controller Box 200 [see FIG. 6] through Data Wire 125.

The faucet front cover 102 with assembled components are coupled to the faucet body 103, and the faucet bottom plate 115. The hose sleeve 110 is coupled to the faucet body 103. The faucet neck 106 is, in this embodiment, coupled to the bearing sleeve 117, o-rings 116, faucet neck union 118 and the faucet body 103. This configuration allows for the faucet neck 106 to be able to rotate freely with respect to the faucet body 103.

In other embodiments (not shown), physical handle(s) can be installed onto the body of the faucet, but instead of the traditional layout where the mixing valve is attached to the handle, a series of potentiometers can be coupled to the handle which send electrical signals to the controller box to control the gears to the thermostatic mixing valve.

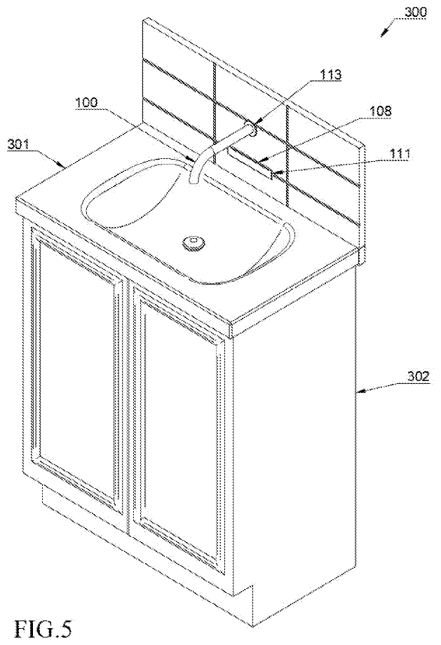

Referring to FIG. 5, in some embodiments, the faucet 100, sensors 108 and camera 111, and electronic display 113 are not all integrated in the same body, as in FIG. 4, but separated and can be installed on the wall. In this embodiment, the controller box 200 (not shown) is below the countertop 301, inside the cabinet 302. The water line (not shown) and data lines 125 (not shown) that communicate to the controller box 200 are routed behind the wall down under the sink and into the cabinet 302. In various embodiments, the relationship between the configuration of the faucet and the sensors are not limited to them being separate as shown, but can be combined, coupled together, completely separate, or any variation or combination as understood by persons of skill in the art.

FIGS. 6-9 describe an exemplary embodiment of the controller box 200, components, and relationships that water sources have in the system. The controller box 200 is coupled directly to a hot water source 402 through the hot water inlet 204 and a cold water source 403 through a cold water inlet 205. FIG. 6 shows a controller box 200 that comprises an electronic control board 207. In accordance with some embodiments, when commanded by the electronic control board 207, motor one 210 transfers power through the first pinion gear 221 and through the idler gear 220 and rotates the flow rate drive gear 201 to control the flow rate on the thermostatic mixing valve 213 responsive to a user's request. The thermostatic mixing valve 213 is actuated in accordance with a user's touchless command. Such touchless commands can be gestures and/or movements by a control object, such as, in various embodiments, a human hand. Coextensively, when commanded by the electronic control board 207, motor two 211 transfers power through the second pinion gear 222 and rotates the temperature drive gear 202 to control the temperature of the output water on the thermostatic mixing valve 213. On the controller box chassis 216, there are, in some embodiments, protrusions (not shown) that act as mechanical stops to prevent the gears 201, 202 from turning past the limit for both flow rate and temperature on the thermostatic mixing valve 213.

The water from the thermostatic mixing valve 213 exits through the outlet tubing 206, passing through the temperature sensor 217, through the solenoid valve 215, through the outlet 214 to the faucet 100 (not shown). As illustrated in FIG. 6, the layout of the inlet and outlet tubings can be designed to be used for prototyping due to the ease of material acquisition and testing. In some manufactured embodiments, the hot water inlet 204, cold water inlet 205, outlet tubing 206, and outlet 214 are all integrated in a premolded chamber (not shown) made out of plastic (i.e. ABS) to reduce material variations, cost, and space consumed. The premolded chamber (not shown) can be coupled to the temperature sensor 217, solenoid valve 215, and the TMV sleeve 209 (not shown).

In various embodiments, the temperature sensor 217 can be electrically coupled to the electronic control board 207. The temperature sensor 217 relays the temperature of the water in the outlet tubing 206 following the thermostatic mixing valve 213 by sending voltage readings to the electronic control board 207. In some embodiments, it is advantageous for the temperature sensor 217 to be mounted to the water line between the thermostatic mixing valve 213 and the solenoid valve 215. The temperature sensor 217 measures the temperature of the water prior to it being sent to the user from the faucet 100. The temperature sensor 217 will send the temperature reading to the electronic control board 207. The electronic control board 207 will then regulate the water temperature and flow rate by adjusting the gears 221, 222 on the thermostatic mixing valve 213 to meet the user's requests.

In some embodiments, the solenoid valve 215 is normally closed when not energized and opens to allow water flow through when energized. In other embodiments, the solenoid valve 215 can be a latching type that opens or closes when energized in order to reduce power consumption. The solenoid valve 215 is, in various embodiments, coupled between the thermostatic mixing valve 213 and the outlet to the faucet 214. Additionally, the solenoid valve 215 can be electrically coupled to the electronic control board 207.

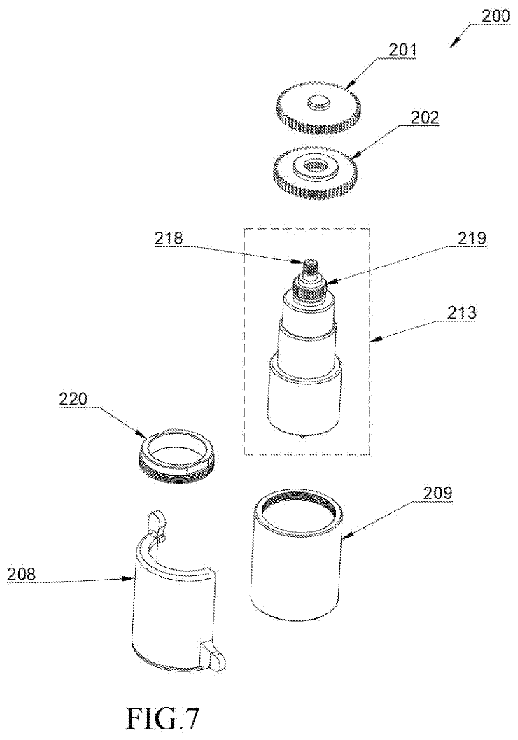

FIG. 7, illustrates a thermostatic mixing valve 213 and electronic components for operating the thermostatic mixing valve 213 in accordance with some embodiments. The flow rate drive gear 201 is coupled to the flow rate spline 218 on the thermostatic mixing valve 213. The temperature drive gear 202 is coupled to the temperature spline 219 on the thermostatic mixing valve 213. All gears may be formed of any material including, but not limited to, plastic or metal. In some embodiments, the gears 201, 202 are formed of acetate or nylon for cost considerations and characteristics such as moldability, durability, and strength.

In various embodiments, the thermostatic mixing valve 213 is coupled into a TMV sleeve 209 and secured by a TMV cap 220. The TMV sleeve 209 has features (not shown) that mate to the extrusions on the thermostatic mixing valve 213 that allow for proper alignment.

Additionally, the thermostatic mixing valve 213 has a gasket (not shown) that seals water from leaking outside the thermostatic mixing valve 213, when compressed onto the TMV sleeve 209. The thermostatic mixing valve 213 is secured to the chassis 216 with a TMV brace 208. In a preferred embodiment, the TMV sleeve 209 and the TMV cap 220 are both formed or machined out of brass (with low lead) for corrosion resistance, durability, water potability, moldability, and cost. Additionally, the TMV brace 208 can be formed out of ABS or an equivalent material as understood by persons of skill in the art.

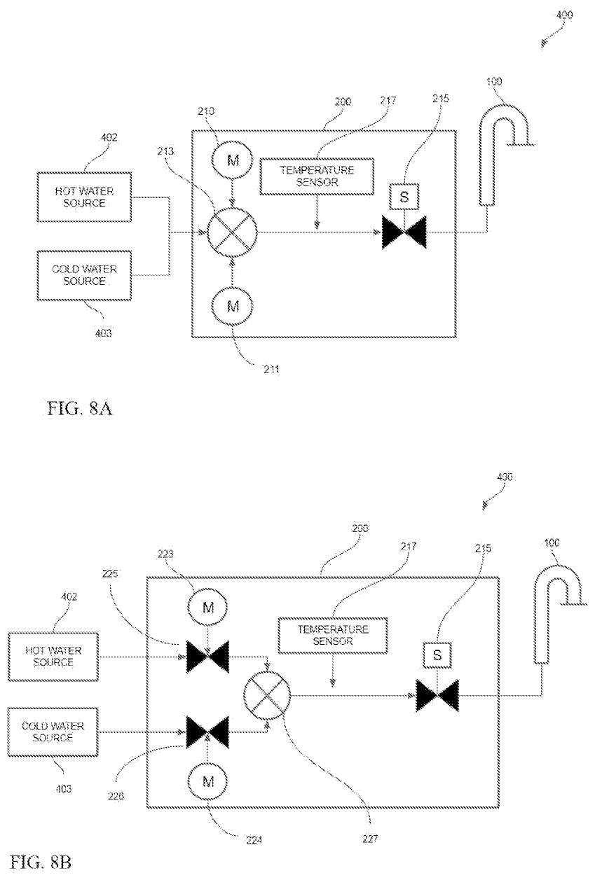

FIGS. 8A and 8B show block diagrams illustrating the mechanical system, water flow path, and interface with the thermostatic mixing valve 213 and solenoid valve 215 that control water temperature and water flow rate in various embodiments. In some embodiments, as shown in FIG. 8A, the controller box 200 comprises a temperature sensor 217, a thermostatic mixing valve 213, a solenoid valve 215, and motors 210 and 211. In some embodiments, as shown in FIG. 8A, the hot water source 402 connects to the hot water inlet 204 (not shown) and the cold water source 403 connects to the cold water inlet 205 (not shown), which both connect directly to a mixing valve. The mixing valve is, in some embodiments, a thermostatic mixing valve 213 that can regulate temperature and flow rate independently of one another through motor one 210 and motor two 211. In some embodiments, as shown in FIG. 8B, a thermostatic mixing valve 213 is not used. Instead, the hot water source 402 connects to the hot water inlet 204 (not shown) and connects to valve 225. The cold water source 403 connects to the cold water inlet 205 (not shown) and connects to valve 226. Valves 225, 226 are, in some embodiments, operably coupled to motors 223 and 224, respectively, to independently regulate their flow rates to adjust the output of water temperature and flow rate mixed in the mixing chamber 227. In FIGS. 8A and 8B, the water exiting from thermostatic mixing valve 213, or valves 225, 226 and mixing chamber 227, enters into the solenoid valve 215 which either permits the flow of water to the end user through faucet 100, or stops the flow of water. The temperature sensor 217 can be attached to the connection between the thermostatic mixing valve 213, or mixing chamber 227 and the solenoid valve 215 to monitor the temperature of the water prior to the water being sent to faucet 100.

The mixing valve, in various embodiments, is coupled to motors 223 and 224 which are coupled to a computer 203 that is coupled to sensors. The computer 203 interprets commands performed by users that are received through the sensors and sends information to control the motors.

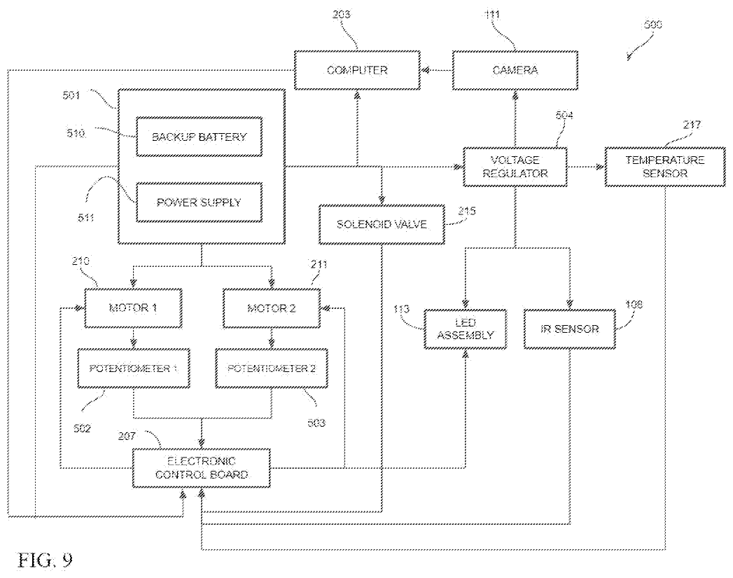

FIG. 9 shows a block diagram illustrating an electronic faucet system in accordance with some embodiments. An electronic control board 207 can interpret information received by the IR sensor 108, camera 111, computer 203, potentiometer one 502, potentiometer two 503, temperature sensor 217, and solenoid valve 215.

Motor one 210 and motor two 211 are, in various embodiments, embedded with potentiometers 502, 503. The potentiometers 502, 503 can relay the position of the motor shaft back to the electronic control board 207 which allows for fine-tune control from the electronic control board 207. The electronic control board 207 can send electrical signals to the motors 210, 211 to a desired amount of “steps” which is relayed by the potentiometers 502, 503.

Due to the nature of hand tracking technology and AI, the computer should be powerful enough to identify and process gestures and interpret the intent of each command. The level of power required for different embodiments is known to persons of skill in the art. The computer 203 mentioned in FIG. 6 and FIG. 9, depict embodiments where the system contains the specifications required to support camera functionality. In some embodiments, the computer 203 is coupled inside the controller box chassis 216. The computer 203 is electrically coupled to the camera 111 and the electronic control board 207. The camera 111 can send images to the computer 203 which in turn interprets the images and determines the intent of the gestures being made or used as commands.

Briefly referring to FIG. 9, in some embodiments, the power system 501 can have an AC power supply 511 that comes directly from a receptacle. In some embodiments there is an additional backup battery 510 installed in the power system 501. In the event of a power outage, the backup battery 510 will take over and engage the power saving mode for the faucet system. The faucet system will disable the camera 111 and computer 203 and only allow the activation of water flow when an obstruction passes in front of the IR sensor 108 detection zone in front of the faucet. In one embodiment, the faucet 100 can default the temperature in the thermostatic mixing valve 213 to cool water which can be represented as 20% hot water and 80% cold water. Then the faucet will also default the flow rate in the thermostatic mixing valve 213 to a 50%-60% flow rate.

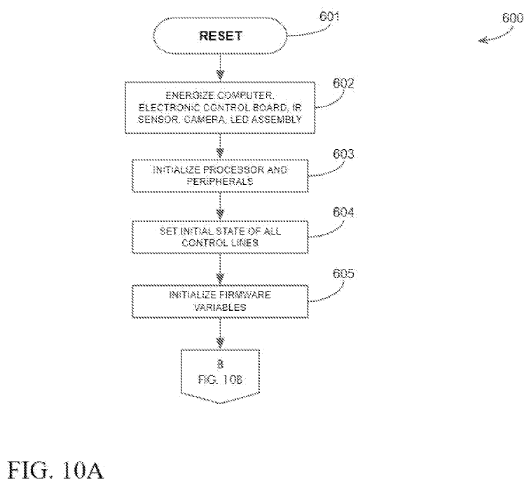

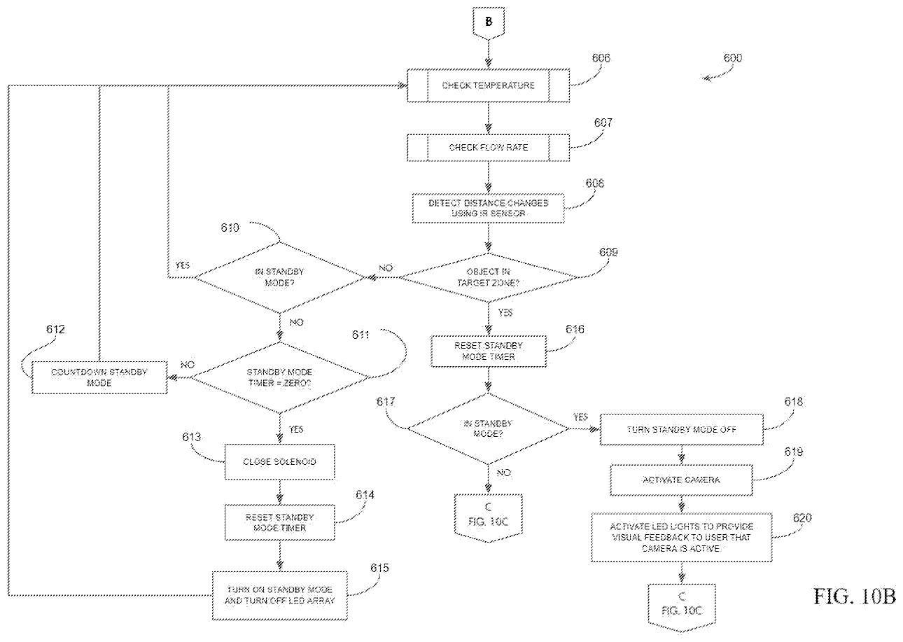

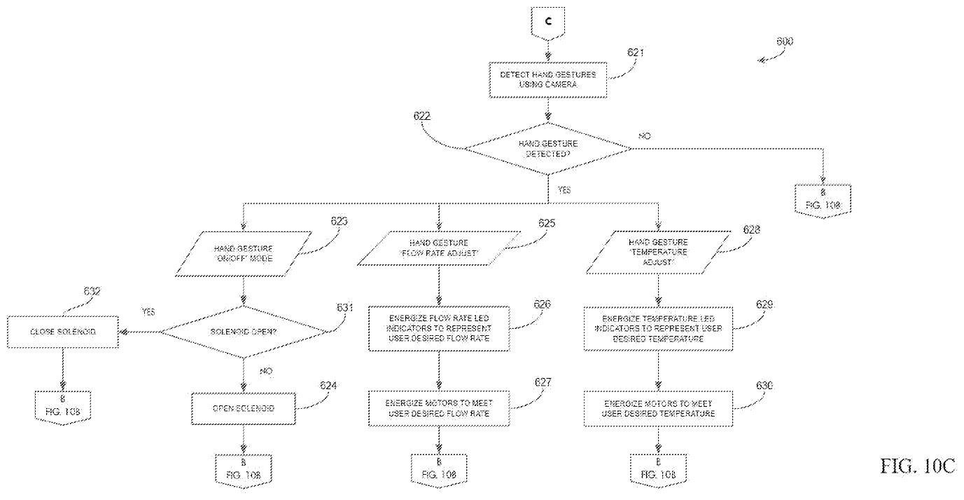

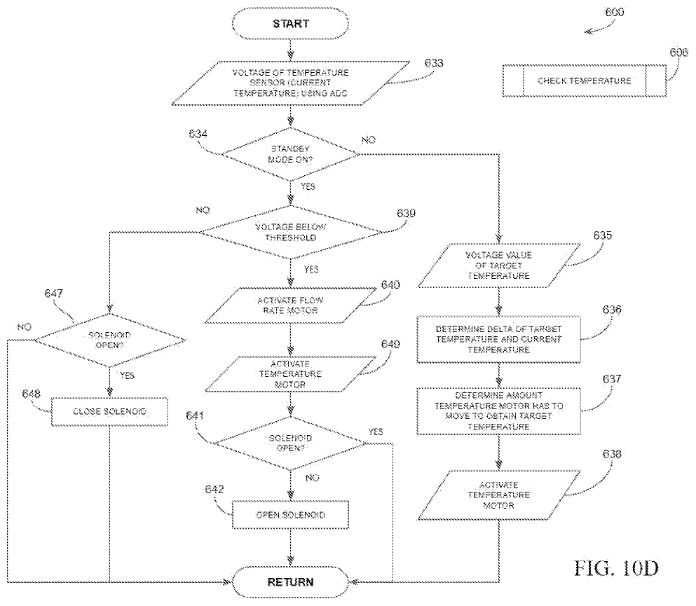

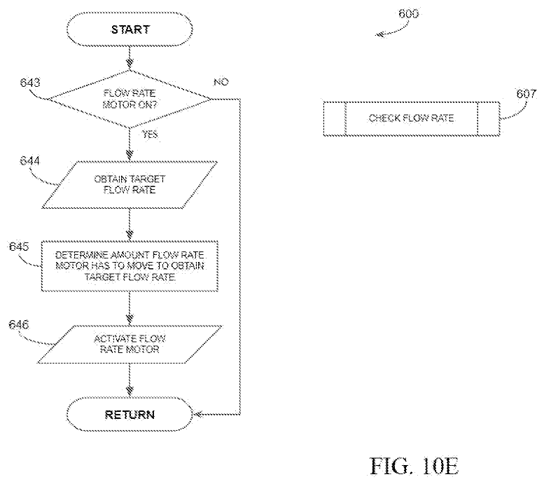

Referring to FIGS. 10A-E, a flow chart of a process 600 for controlling a faucet, is shown according to an exemplary embodiment.

Referring to FIG. 10A, a series of steps for initializing the system during system startup. At any point when the controller box is first powering up, the process will start from RESET (step 601) to begin initializing the system. The computer 203, the electronic control board 207, the IR sensor 108, the camera 111, and the LED Assembly 113 all have to be energized in order to begin functioning (step 602). From there, all electronic components not integral to the operation of the faucet will turn on (step 603). Motors one 210 and motor two 211, potentiometers 502, 503, and the solenoid valve 215 will reset their initial positioning to establish their default or “zero” positions (step 604). Lastly, before beginning operation, all variables in software existing in the electronic control board 207 and computer program are initialized and reset (step 605). From there, the process ends the start-up phase (FIG. 10A) and proceeds to FIG. 10B.

FIG. 10B shows a series of logical steps for determining active mode or standby mode. The process 600 is shown to include steps for subroutines “Check Temperature” (step 606), “Check Flow Rate” (step 607), and determining if the computer 203 is in standby mode or not (steps 608-620). The IR Sensor 108 will actively look for an object (step 608) that enters the field of detection, the target zone (step 609). If the IR Sensor 108 does not detect any objects in the target zone (step 609), the electronic control board 207 will determine if the computer 203 is in standby mode or not (step 610). If the computer 203 is determined to be in standby mode, it will immediately return to the check temperature subroutine and then repeat the cycle (steps 606 610) until an object is observed in the target zone (step 609). If the computer 203 is determined to not be in standby mode, the program will check the timer for standby mode and determine if it is zero (step 611). If the standby mode timer is not zero (step 611), the standby mode timer counts down one instance (step 612), then the process will immediately return to the check temperature subroutine and then repeat the cycle (steps 606-611) until an object is observed in the target zone (step 609). If the standby mode timer is zero (step 611), the electronic control board 207 will close the solenoid 215 (step 613), then reset the standby mode timer (step 614), turn the computer 203 to standby mode and de-energize the LED assembly 113 (step 615), and then the process will immediately return to the check temperature subroutine and then repeat the cycle (steps 606-610) until an object is observed in the target zone (step 609).

According to an exemplary embodiment, an object entering the target zone (step 609) the first time causes the process 600 to reset the standby mode timer (step 616) and turn the standby mode OFF (step 618), activates the camera 111, the computer 203, and activates the LED assembly 113 to inform the user that the camera 111 is “actively looking for commands” (step 620). An object entering the target zone (step 609) at any time when the computer 203 is not in standby mode, the process will still reset the standby mode timer (step 616), then immediately proceed to FIG. 10C, to begin the functions for detecting hand gestures.

Referring to FIG. 10C, the process 600 is shown to include steps for detecting hand gestures and determining hand gesture commands. The computer 203, having been preconfigured with a library of object recognition and gesture recognition, will actively recognize and track a user's hand, looking for hand gesture commands by utilizing the camera 111 (step 621). Once a hand gesture command is recognized (step 622) it will perform one of three functions, but the process 600 is not limited to the three commands or functions below (steps 623, 625, 628). If no hand gesture is detected (step 622), the process 600 will immediately return to Point B and repeat steps on FIGS. 10B and 10C.

Hand Gesture “ON/OFF” Mode (step 623) enables the discharge of water by opening the solenoid valve 215 (step 624), if the solenoid valve 215 is closed (step 631) or disables the discharge of water by closing the solenoid valve 215 (step 632), if the solenoid valve 215 is open (step 631).

Hand Gesture “Flow Rate Adjust” (step 625) adjusts the water flow rate by activating motor one 210, which increases or decreases the orifice of the mixing valve outlet 213 (step 627). The relative position of the motor one 210 is relayed through a potentiometer 502 to the electronic control board 207. The electronic control board 207 will also energize the LED assembly 113 to provide visual feedback to the user of their selection (step 626).

Hand Gesture “Temperature Adjust” (step 628) adjusts the water temperature by activating motor two 211, which changes the ratio of cold water to hot water in the mixing valve 213 (step 630). The relative position of the motor two 211 is also relayed through a potentiometer 503 to the electronic control board 207. The electronic control board 207 will also energize the LED assembly 113 to provide visual feedback to the user of their selection (step 629).

Referring now more specifically to FIG. 10D, the process 600 is shown to include a subroutine for checking temperature (step 606) using the temperature sensor 217. The temperature sensor 217 measures the temperature as an analog reading, converts the analog voltage reading of the device into a digital value, and sends that value to the electronic control board, where it is converted into a temperature reading (step 633). The process will check if the system is in standby mode (step 634). If the system is not in standby mode, the process will take new measurements from the temperature sensor 217 and compare the reading to the target temperature requested by the user (step 635, 636). The electronic control board 207 determines the ratio between hot and cold that is required to meet the target temperature (step 637). The electronic control board 207 utilizes this difference and activates motor two 211 that controls temperature regulation and adjusts it to achieve the desired temperature (step 638).

In the event that standby mode is ON (step 634), the process 600 will run through a series of functions to check for freezing water in the residential pipes (steps 639, 640, 641, 642, 647 and 648). The threshold defined in step 639 is a temperature that is preset by the manufacturer that represents conditions in the household where the ambient temperature is lower than minimum to prevent freezing pipes. For example, in one embodiment, the threshold could be set to a voltage that represents 40 degrees Fahrenheit (˜4 degrees Celsius). If the temperature sensor 217 reads a value of 40 degrees Fahrenheit (˜4 degree Celsius) or lower, it will activate the flow rate motor 210 to an amount sufficient to allow water to circulate through the pipe. Additionally, in some embodiments, the electronic control board 207 will activate the temperature motor 211 to be a ratio of 50% hot and 50% cold to allow even purging of both lines so that neither freeze.

Referring now more specifically to FIG. 10E, the process 600 is shown to include a subroutine for checking flow rate (step 607). The process 600 checks to see if the flow rate motor 210 is on (step 643), if it is observed to be ON, the electronic control board 207 will request for readings (step 644) from the flow rate motor's potentiometer 502. Then using the value from the potentiometer 502 and comparing it to the user's target flow rate request (step 645), the electronic control board 207 will send signals to move the motor 210 the appropriate amount to meet the user's target request (step 646). If the flow rate motor 210 is not ON, then the process will immediately return to the main branch and continue to the next line in the block diagram. (step 643).

### Manufacturing Methods:

Assembling a faucet in accordance with various embodiments described herein can be accomplished by the following steps:
1. Install O-Rings into Hose Sleeve.
2. Thread Hose Sleeve onto Faucet Body until Hose Sleeve Bottoms out.
3. Thread Faucet Neck Union onto Faucet Body until Faucet Neck Union Bottoms out.
4. Install Bearing Sleeve over Faucet Neck Union with the button oriented towards the bottom.
5. Install O Rings onto Faucet Neck Union in appropriate grooves.
6. Install Faucet Neck onto Faucet Neck Union and Bearing Sleeve until cutout in Faucet Neck Engages into Bearing Sleeve protrusion.
7. Install Camera onto Faucet Body using hardware.
8. Install LED Assembly onto Faucet Front Cover.
9. Install IR Sensor onto Faucet Front Cover using hardware.
10. Install Camera Protective Cover onto Faucet Front Cover using adhesive.
11. Connect electrical cables from IR sensor, Camera
12. Install Faucet Front Cover onto Faucet Body using hardware.
13. Feed Electrical Cables through hole in Bottom Plate, install Bottom Plate onto Faucet Body using hardware.
14. Install Gasket into Bottom Plate.
15. Install Bottom Plate into Faucet Body using hardware, ensure Hose Sleeve clears hole in Bottom Plate.
16. Install Faucet Shank into Hose Sleeve.
17. Install hose into thread of Faucet Spout.
18. Feed hose through Faucet Neck and pull through the hose sleeve and out from the Faucet Shank.
19. Install Faucet Assembly as is onto countertop and feed Faucet Shank through hole provided in the countertop.
20. Install Rubber washer and metal washer onto the Faucet Shank and thread the Lock nut and screws onto the Faucet shank.
21. Thread the lock nut until the rubber washer and faucet compress onto the countertop.
22. When the lock nut is sufficiently tightened, evenly turn the screws to apply even more clamping force onto the countertop.
23. Connect all water lines and electrical connections to the controller box.

Assembling a controller box that can be used in accordance with various embodiments described herein can be accomplished by the following steps
1. Install each Motor (2×) into each Motor Bracket (2×) using hardware.
2. Install each Gear (2×) into each Motor and secure using a set screw.
3. Install Gear into Location top of Case using hardware.
4. Install Thermostatic Valve into Valve Brass Base and secure using Valve Brass Cover.
5. Install Temperature Gear and Pressure Gear onto Thermostatic Valve.
6. Install 3×pipes (2×inlet and 1×outlet) into the Thermostatic Valve.
7. Install Thermostatic Valve with Brass Base into Case and secure using hardware and Valve Cover.
8. Install Temperature Sensor into outlet line.
9. Install Solenoid into Outlet Line.
10. Install adapter for 2×Inlet and 1× Outlet.
11. Install Motors with Bracket onto Case using Hardware.
12. Install electronic control board.
13. Install Computer.
14. Connect wiring from LED inlet cables, motors, solenoid valve, and temperature sensor to electronic control board.
15. Connect wiring from Hand Sensor inlet line and electronic control board to computer. electronic control board.
16. Install Front Cover of Case using hardware.

1. A touchless plumbing fixture comprising:
a discharge outlet with a passageway to conduct water in fluid communication with a mixing valve, the mixing valve in fluid communication with a cold water source and a hot water source, the mixing valve is operably coupled to one or more motors to independently control water flow rate and water temperature;
an electrically operable valve in fluid communication with the passageway to conduct water, positioned between the mixing valve and the discharge outlet;
a sensor with a field of detection for detecting a user control object in three dimensional sensory space; and
a computer system operably coupled to the sensor, to the one or more motors, to the electrically operable valve, and one or more electronic components, and comprising a searching mode that uses the sensor to capture an image, find a control object, create a 3D model of the control object, apply reference points to the 3D model, then determine an axial position for the reference points on the 3D model, and analyze the axial positions of the reference points to recognize a plurality of gestures as commands.

2. The touchless plumbing fixture of claim 1, wherein the electrically operable valve is a solenoid valve.

3. The touchless plumbing fixture of claim 2, wherein the solenoid valve enables or disables the flow of water through the plumbing fixture independently of the setting of the mixing valve.

4. The touchless plumbing fixture of claim 1, wherein the one or more electronic components are selected from a group consisting of one or more motors, one or more sensors with one or more fields of detection, one or more electrically operable valves, an electronic display, and combinations thereof.

5. The touchless plumbing fixture of claim 1, wherein the one or more electronic components further comprises an electronic display that presents information about water temperature, water flow rate, an active state, a mode, or combinations thereof to the user.

6. The touchless plumbing fixture of claim 1, wherein the computer system further comprises an electronic control board that sends and receives signals to and from the one or more electronic components.

7. The touchless plumbing fixture of claim 1, wherein the user control object is a hand or a pair of hands.

8. The touchless plumbing fixture of claim 1, wherein the plurality of gestures are selected from a group consisting of hand gestures, poses, speech, sounds, other body gestures, and various combinations thereof.

9. The touchless plumbing fixture of claim 1, wherein the plurality of gestures are selected from a group consisting of a water temperature gesture, a water flow rate gesture, a gesture to activate and deactivate the electrically operable valve, and combinations thereof.

10. The touchless plumbing fixture of claim 1, further comprising a second sensor with a secondary field of detection.

11. The touchless plumbing fixture of claim 10, wherein the computer system is preconfigured to switch between an active mode and a standby mode and when the computer system is in the standby mode and the second sensor detects the control object in the secondary field of detection the computer system will switch to the active mode.

12. The touchless plumbing fixture of claim 11, wherein when the second sensor does not detect the user in the secondary field of detection after a predefined period of time, the computer system will switch to the standby mode.

13. The touchless plumbing fixture of claim 1, wherein the computer system is preconfigured to switch between an active mode and a standby mode and when the computer system is in the standby mode and the sensor detects the control object in the field of detection the computer system switches to the active mode.

14. The touchless plumbing fixture of claim 13, wherein when the sensor does not detect the user in the field of detection after a predefined period of time, the computer system switches to the standby mode.

15. The touchless plumbing fixture of claim 1, wherein the sensor is one or more digital cameras.

16. The touchless plumbing fixture of claim 1, wherein the sensor is one or more infrared cameras.

17. The touchless plumbing fixture of claim 1, wherein the one or more electronic components is an audio sensor operably coupled to the computer system for detecting audio commands or an audio device for providing audio feedback of command recognition to the user.

18. The touchless plumbing fixture of claim 1, wherein the mixing valve is a mixing chamber.

19. The touchless plumbing fixture of claim 1, wherein a temperature sensor is operably coupled to the computer system that is preconfigured with an anti-freeze mode to prevent the water from freezing.

20. The touchless plumbing fixture of claim 19, wherein water temperature is measured by output signals from the temperature sensor while the computer system is not in operation and when the water temperature falls below a preconfigured threshold then the computer system begins the anti-freeze mode and activates the electrically operable valve.

21. The touchless plumbing fixture of claim 20, wherein while in the anti-freeze mode the computer system continually monitors the water temperature by measuring the output signals of the temperature sensor and when the water temperature is above the preconfigured threshold then the computer system ends the anti-freeze mode and deactivates the electrically operable valve.

22. The touchless plumbing fixture of claim 1, wherein the discharge outlet is a spout.

23. The touchless plumbing fixture of claim 1, wherein the plumbing fixture is selected from a group consisting of sink, a shower, a tub, a fountain, and combinations thereof.

24. The touchless plumbing fixture of claim 1, wherein the plumbing fixture is a faucet.

25. The touchless plumbing fixture of claim 1, wherein the computer system is configured to recognize user control objects and gestures by analyzing images captured by the sensor from a particular vantage point to computationally represent a portion of the user control object from the plurality of user control objects as one or more mathematically represented 3D surfaces.

26. The touchless plumbing fixture of claim 25, wherein each 3D surface corresponding to a cross-section of the portion of the user control object is recognized from a plurality of edge points of the portion of the user control object in the image, tangent lines extending from the sensor to at least two edge points of the plurality of edge points, a centerline corresponding to the tangent lines, or combinations thereof, to reconstruct, or shape fit, the user control object in 3D space.

27-29. (canceled)

30. The touchless plumbing fixture of claim 1, wherein the computer system continuously operates in searching mode until the axial position of the image matches a preconfigured gesture stored in the computer system and wherein, when the image that matches the preconfigured gesture becomes an active gesture the computer system switches to a matching mode.

31. The touchless plumbing fixture of claim 30, wherein when in the matching mode, the computer system interfaces with the sensor to continuously capture a new image, as a current image, after a predefined period of time and compares the current image with a previously captured image, as a prior image.

32. The touchless plumbing fixture of claim 31, wherein the current image is one most recently captured and the prior image is the one immediately preceding the current image and for each image, the computer system finds a control object, creates a 3D model of the control object, applies reference points to the 3D model, determines the axial position for the reference points on the 3D model, and confirms the axial position matches the active gesture.

33. The touchless plumbing fixture of claim 32, wherein the computer system determines the difference between the axial positions of the current image and the prior image and then correlates that difference into a change in the state of the plumbing fixture recognized by the active gesture.

34. The touchless plumbing fixture of claim 33, wherein the computer system continuously operates in the matching mode until parameters to end matching mode are met and then the computer system will switch to the searching mode.

35. (canceled)

36. A system for touchless control of water flow rate and temperature comprising:
a discharge outlet with a passageway to conduct water in fluid communication with a mixing valve;
the mixing valve in fluid communication with a cold water source and a hot water source and operably coupled to one or more motors for independent control of water flow rate and water temperature;
an electrically operable valve in fluid communication with the passageway to conduct water, positioned between the mixing valve and the discharge outlet;
a sensor with a field of detection for detecting a user control object in three dimensional sensory space; and
a computer system operably coupled to the sensor, to the one or more motors, to the electrically operable valve, and one or more electronic components and comprising a searching mode that uses the sensor to capture an image, find a control object, create a 3D model of the control object, apply reference points to the 3D model, and then determine an axial position for the reference points on the 3D model, and analyze the axial positions of the reference points to recognize a plurality of gestures as commands.

37-68. (canceled)

69. A touchless hand tracking faucet, comprising:
a spout with a passageway to conduct water in fluid communication with a mixing valve;
the mixing valve in fluid communication with one or more water source and operably coupled to one or more motors to independently control water flow rate and water temperature;
an electrically operable valve in fluid communication with the passageway to conduct water and positioned between the mixing valve and the spout;
a sensor with a field of detection for detecting a user control object in three-dimensional sensory space; and
a computer system operably coupled to the sensor, to the one or more motors, and to the electrically operable valve, and one or more electronic components and comprising a searching mode that uses the sensor to capture an image, recognize a user's hands as a control object, find the control object, create a 3D model of the control object, apply reference points to the 3D model, and then determine an axial position for the reference points on the 3D model, and analyze the axial positions of the reference points to recognize a plurality of gestures as commands.

70-109. (canceled)
